(19) United States
(12) Patent Application Publication
(10) Pub. No.: US 2010/0179974 A1
(43) Pub. Date: Jul. 15, 2010

(54) Signal Processing Method for Hierarchical Empirical Mode Decomposition and Apparatus Therefor

(75) Inventors: Sun-Hua Pao, Taipei City (TW); Chien-Lun Tseng, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INDUSTRIAL TECHNOLOGY RESEARCH INSTITUTE, Hsinchu (TW)

(21) Appl. No.: 12/684,446

(22) Filed: Jan. 8, 2010

(30) Foreign Application Priority Data
Jan. 10, 2009 (TW) 98100867
Dec. 24, 2009 (TW) 98144865

(51) Int. Cl. G06F 17/14; G06F 17/10; G06F 7/00

(52) U.S. Cl. 708/207; 708/400; 708/311

(57) ABSTRACT

A signal processing method for performing hierarchical empirical mode decomposition (H-EMD) and an apparatus therefor are provided. In an embodiment, when empirical mode decomposition is performed on an input signal, an artificial assisting signal and the input signal are combined to assist the search for extrema and frequency reduction is performed in each iteration to eliminate the artificial assisting signal and make mode decomposition convergent so as to avoid mode mixing. In addition, in an embodiment, a hierarchical decomposition method is provided to decompose the input signal into a fewer number of fundamental modes. For needs in application, one of the fundamental modes can be further decomposed to produce a number of supplementary modes. In an embodiment, the H-EMD with appropriate frequency reduction can result in modes substantially independent of the form or the way of envelopes and can be applied to decompose multi-dimensional signals.

This application claims the benefit of Taiwan applications Serial No. 98100867, filed Jan. 10, 2009 and No. 98144865, filed Dec. 24, 2009, the subject matter of which is incorporated herein by reference.

### TECHNICAL FIELD

The invention relates in general to a signal processing method and more particularly to a signal processing method for performing empirical mode decomposition in nonlinear and nonstaionary dataset.

### BACKGROUND

N. E. Huang (Huang N. E.) provides an empirical mode decomposition (EMD) method for the decomposition of non-stationary and non-linear signals. The algorithm for signal decomposition decomposes a time-related signal into a number of intrinsic mode functions (IMF) mixed with signal monotonic functions.

In recent years, two-dimensional EMD method is already provided. There are two categories of EMD methods, namely, single directional EMD methods (U.S. Pat. No. 6,311,130) and two-dimensional interpolation function based EMD methods. The single directional EMD methods treat an image as a vertical one-dimensional signal and a horizontal one-dimensional signal and have simple procedures, so the processing speed is faster. However, the relations between rows and columns in an image are neglected. The two-dimensional interpolation function based EMD methods resolve the above problem by performing triangulation or applying interpolation to radial basis function to obtain space-related envelopes. To resolve the extreme value problem occurring to two-dimensional images, Xu Guanlei adopts neighborhood limited EMD (NL-EMD), which determines the number of extreme values within the specified pixel range through artificial search of extreme values, and the inadequate extremities are compensated artificially. The two-dimensional interpolation function based EMD methods are hard to be adapted or applied to high dimensional data.

The empirical mode decomposition method provided by N. E. Huang still has some critical problems to be resolved. The one-dimensional empirical mode is originally configured on analog signals or discrete signals with higher resolution levels, and does not have problems in determining the extreme values for constructing the top envelope and the bottom envelope. Despite the above procedure is used, mode mixing still may occur. In other words, a mode being mixed is no longer an intrinsic mode. As indicated in FIG. 1, if the original signal S is decomposed into modes IMF0 and IMF1, then high-frequency signal and low-frequency signal can no longer be separated. Such situation is even worse in two-dimensional images, and may even result in grey spots.

To resolve the above problems, Z. Wu and N. E. Huang add white noises to the original data, and once a group of intrinsic mode functions (IMF) is obtained, the above step is repeated but different noises are added to decompose the image into another group of IMFs. Several groups of IMF are obtained, averaged and used as the final results of decomposition. This method is called “ensemble empirical mode decomposition (E-EMD) method” which is capable of eliminating white noise and mode mixing. As white noises will be left on the original signal, the residuals of artificial noises have to be eliminated through many times (tens to a hundred) of repeated computing and averaging. Despite the mode mixing can be eliminated, two problems still occur. One problem is that the computing time is significantly increased to be tens or hundreds times of the original computing time, which is very disadvantageous to the computing of high dimensional data (2D above). The other problem is that as the white noises added every time are similar but not identical, the modes generated in each time are slightly different. As the decomposition procedure is self-adapted, the difference in the mode includes the difference in residual noises and the difference in the intrinsic mode. The difference in residual noises will diminish and converge after many times of averaging, but the difference in intrinsic mode makes the mode even cloudier, especially when a larger amount of white noises is added.

As for the E-EMD, the number of IMFs obtained from each time of decomposition may not be the same, and each group of IMFs may not belong to the same frequency-band. Therefore, it is not guaranteed that the IMFs averaged by the E-EMD method have the same frequency-band. To the contrary, the IMFs being averaged may have different frequency-bands and result in the problem of mode mixing as usual. As indicated in FIG. 2, the original signal S is a linear combination of a high-frequency signal and a low-frequency signal, and the mode IMF0 obtained from the decomposition by the E-EMD method is a correct mode. However, the modes IMF1 and IMF2, which come after the mode IMF0, are distorted due to the interference by the noises.

Thus, the problem of mode mixing still occurs to the conventional EMD method and the E-EMD method. The E-EMD method decreases the mode mixing problem but causes the computing time to increase significantly, and is therefore hard to be applied to the empirical mode decomposition for high dimensional data.

Another critical problem is that during the process of EMD, decomposition is performed by way of envelope squeezing, so the research in every aspect is directed to an optimum enveloping method to obtain appropriate modes. There are two types of conventional envelope, namely, triangulation and radial basis, and different types of envelopes lead to different results in mode decomposition. N. E. Huang provides a cubic spline as an optimum empirical solution for one-dimensional decomposition, but there is no optimum empirical solution for two-dimensional (or higher) decomposition. Therefore, various enveloping methods are provided. However, these enveloping methods produce different results in mode decomposition with prior basis which would cause faults in nonlinear system.

### BRIEF SUMMARY

Embodiments of a signal processing method and apparatus for performing empirical mode decomposition (EMD) applicable to the empirical mode decomposition of one-dimensional or multi-dimensional data or signals are disclosed. In an embodiment, an artificial assisting signal is used to assist the search for extrema, and frequency reduction is performed in each iteration to eliminate the artificial assisting signal and make mode decomposition convergent, largely decreasing or avoiding the occurrence of mode mixing to result in frequency-band decomposition. Besides, an embodiment provides H-EMD with appropriate frequency reduction which can result in modes substantially independent of the form or the way of envelopes.

An exemplary embodiment of a signal processing method for performing empirical mode decomposition for an input signal is provided. The method includes the following steps. An artificial assisting signal and the input signal are combined to obtain an assisted input signal. According to the EMD method, the assisted input signal is decomposed by way of iteration to obtain a number of modes. A frequency reduction for an average envelope is performed in each iteration to produce a frequency-reduced average envelope, wherein each mode is obtained by removing the frequency-reduced average envelope from the assisted input signal by way of iteration.

An exemplary embodiment of a signal processing apparatus for performing empirical mode decomposition to an input signal is provided. The apparatus includes an input device, a memory, a processing module and an output unit. The input device is for reading an input signal. The memory unit is for storing a data signal of the input signal. The processing module is for combining an artificial assisting signal and the data signal to obtain an assisted input signal, and for performing empirical mode decomposition to the assisted data signal by way of iteration to obtain a number of modes. In each iteration, the processing module further performs a frequency reduction on an average envelope to produce a frequency-reduced average envelope. The processing module removes the frequency-reduced average envelope from the assisted input signal by way of iteration to obtain the modes. The output unit is for outputting the mode.

Another exemplary embodiment of a signal processing apparatus is provided. The signal processing apparatus includes an extrema searching module, an average envelope module, a frequency reduction module and a determination circuit. The extrema searching module receives a first signal to search for maxima and minima from the first signal. The average envelope module constructs an average envelope according to the maxima and the minima. The frequency reduction module performs frequency reduction on an average envelope to construct a frequency-reduced average envelope. The determination circuit is coupled to the frequency reduction module, wherein if a component signal satisfies a mode condition, then the determination circuit outputs the component signal as a mode. The component signal is obtained by subtracting a frequency-reduced average envelope from the first signal. If the component signal cannot satisfy the mode condition, then the determination circuit outputs the component signal as a first signal of the extrema searching module.

It is to be understood that both the foregoing general description and the following detailed description are exemplary and explanatory only and are not restrictive of the disclosed embodiments, as claimed. The following description is made with reference to the accompanying drawings.

### BRIEF DESCRIPTION OF THE DRAWINGS

FIG. 1 shows one-dimensional signal and its modes obtained according to conventional EMD mode decomposition.

FIG. 2 shows the same one-dimensional signal and its mode obtained according to conventional E-EMD mode decomposition.

FIG. 3A shows a flowchart of a signal processing method for performing empirical mode decomposition according to an embodiment of the invention.

FIG. 3B shows a signal processing method for performing empirical mode decomposition according to an embodiment of the invention.

FIG. 4 shows an embodiment of the step 340 of FIG. 3B.

FIG. 5 shows a block diagram of an embodiment of a signal processing system for mode decomposition.

FIG. 6 shows a block diagram of an embodiment of a processing module for mode decomposition.

FIG. 7 shows a block diagram of an embodiment of a sifting module for mode decomposition.

FIG. 8 shows an example of a one-dimensional signal being decomposed into two fundamental modes according to the hierarchical EMD method of an embodiment of the invention.

FIG. 9 shows a processing procedure for decomposing supplementary modes according to the hierarchical EMD method of an embodiment of the invention.

FIGS. 10A-10D show an embodiment of hierarchical EMD method showing appropriate frequency reduction leading to similar results of decomposition, independent of different envelope curve method.

FIG. 11 shows a brain wave signal being decomposed into multiple modes according to a conventional empirical mode decomposition.

FIG. 12 shows the brain wave signal of FIG. 11 being decomposed into multiple modes according to an example of hierarchical EMD method of the invention.

### DETAILED DESCRIPTION

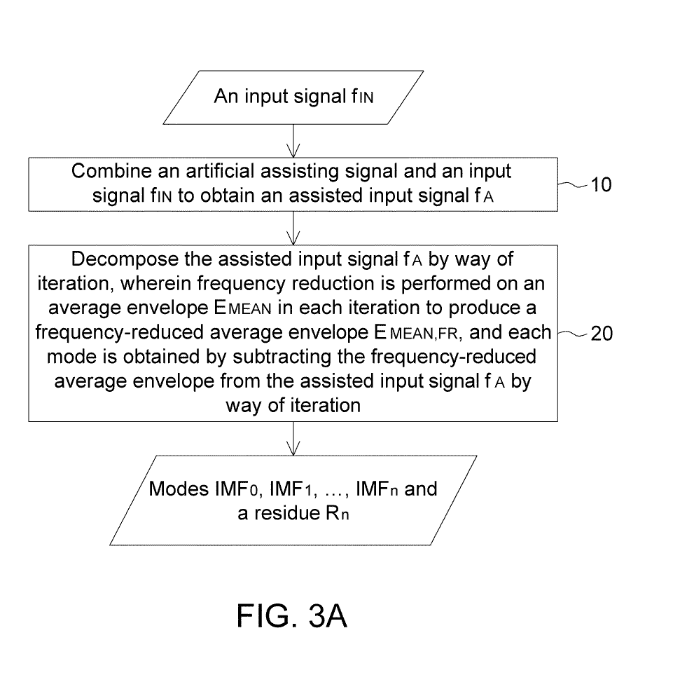

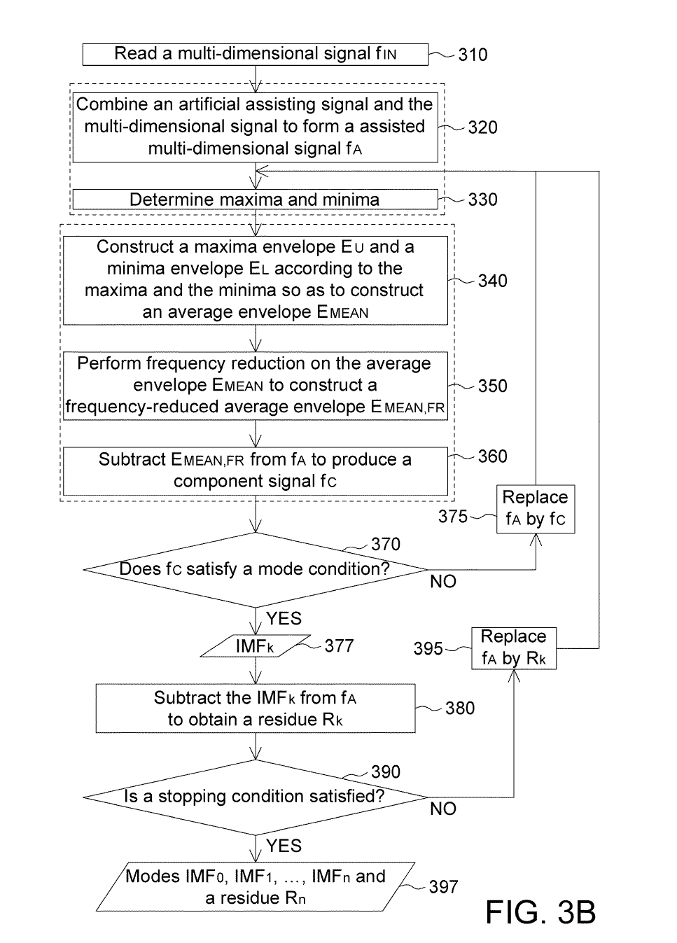

An embodiment is directed to an empirical mode decomposition (EMD) method, which enhances the orthogonality among the obtained modes (i.e., intrinsic mode functions) by using an artificial assisting signal and frequency reduction and is applicable to the empirical mode decomposition of one-dimensional or multi-dimensional data or signals. FIG. 3A shows a flowchart of a signal processing method for performing empirical mode decomposition according to an embodiment of the invention. As indicated in step 10, an artificial assisting signal and an input signal f_{IN} are combined (e.g., added together) to obtain an assisted input signal f_{A} to assist the search of extrema of the artificial assisting signal f_{A}. In step 20, the assisted input signal f_{A} is decomposed according to EMD method by way of iteration to obtain a plurality of modes, wherein frequency reduction is performed on an average envelope E_{MEAN} in each iteration to produce a frequency-reduced average envelope E_{MEAN,FR}, and each mode is obtained by subtracting the frequency-reduced average envelope from the assisted input signal by way of iteration. Besides, the frequency reduction would cancel the side effect of the prior basis in envelope generation. Lastly, a number of modes IMF₀, IMF₁, . . . , IMFₙ and a residual function (or called residue) Rₙ are obtained. The elimination of the artificial assisting signal and the convergence of mode decomposition occur concurrently by way of frequency reduction so as to result in frequency-band decomposition and decrease or even avoid the occurrence of mode mixing. The input signal denotes one-dimensional data or signal f_{IN} (x) or multi-dimensional data or signal f_{IN} (x₁, x₂, . . . , xₙ).

During the iterative process, with appropriate frequency reduction, the EMD of an embodiment according to the invention obtains the similar number of modes as the conventional empirical mode decomposition (EMD) would do. If frequency reduction is substantial, then a number of decomposed modes can be merged as a “fundamental mode”. Also, in an embodiment, a hierarchical decomposition method is provided. Firstly, data are decomposed into a fewer number of fundamental modes. Next, for needs in application, every fundamental mode is further decomposed to produce a number of supplementary modes. The hierarchical decomposition method is disclosed by embodiments below. Thus, the computing time of multi-dimensional EMD can be greatly reduced, and the decomposition of data is made more flexible and efficient.

A decomposition method is referred to as a hierarchical empirical mode decomposition (H-EMD) method and is regarded as an embodiment of the invention as long as the decomposition method includes a step of adding an artificial assisting signal and performing frequency reduction to enhance the orthogonality among the obtained modes regardless whether supplementary modes are produced or not.

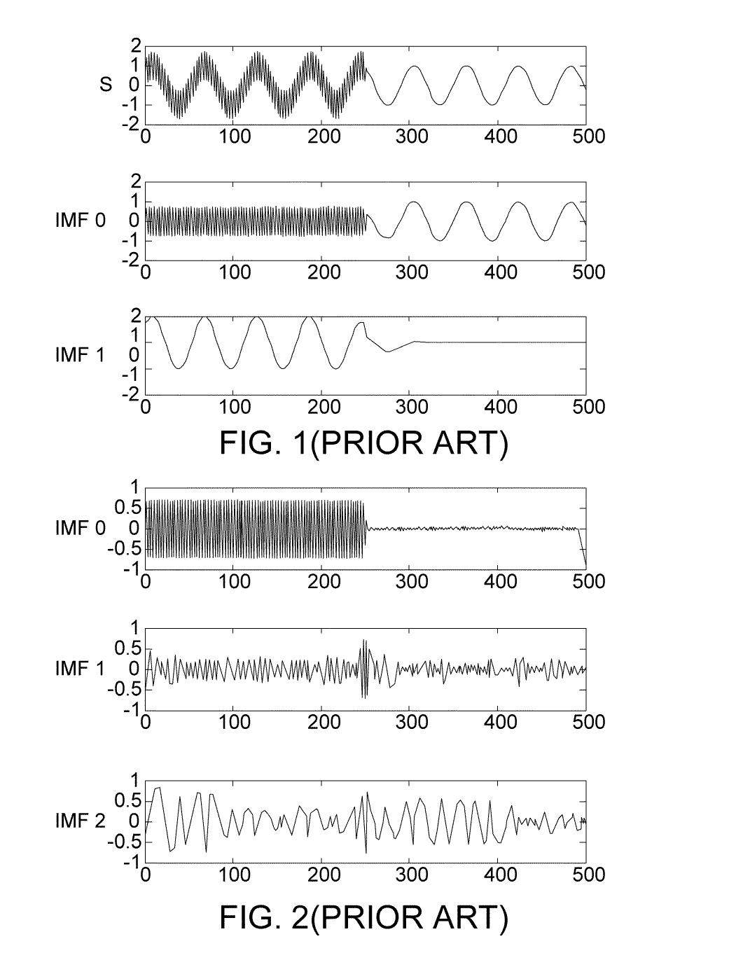

For example, in an embodiment, a uniform noise is used as an artificial assisting signal, and the noise is eliminated in each iteration to make mode decomposition convergent. In the present embodiment, when a mode is obtained, by adding the noise for one time and performing an accompanied smoothing process, low-frequency components will not occur in high-frequency portion, and low-frequency will not be hidden in high-frequency portion, hence resulting in frequency-band decomposition. As indicated in FIG. 8, the original one-dimensional signal is a linear combination of a high-frequency mode and a low-frequency mode, and the signal is further decomposed into the modes IMF0 and IMF1 by the H-EMD method. Compared with the mode decomposition and the results that are obtained by conventional methods and are indicated in FIGS. 1 and 2, the modes IMF0 and IMF1 of FIG. 8 are correct modes.

Referring to FIG. 3B, a signal processing method for performing empirical mode decomposition according to an embodiment of the invention is shown. As indicated in FIG. 3B, in step 310, a group of multi-dimensional data is read, wherein the group of multi-dimensional data is such as a two-dimensional image C[i,j], and C[i,j] denotes the brightness value at the image coordinate (i,j). In a broader sense, a number of groups of data, or data or signals that are presented in different forms (signals such as physical signals, physiological signals such as signals or electro-cardio signals, or other signals) can be regarded as a multi-dimensional signal f_{IN} (x₁, x₂, . . . , xₙ). In step 320, an artificial assisting signal and the multi-dimensional signal (or the group of multi-dimensional data) are combined, such as added together, to form a multi-dimensional signal f_{A} combined with the artificial assisting signal (or a group of multi-dimensional data f_{A} combined with the artificial assisting signal) which is referred to as an assisted signal (or an assisted group of data) for the sake of brevity. In step 330, maxima and minima are searched for (or determined) from the assisted signal f_{A}. In step 340, a maxima envelope E_{U} and a minima envelope E_{L} are respectively constructed according to the maxima and the minima, and an average envelope E_{MEAN} is constructed according to the maxima envelope E_{U} and the minima envelope E_{L}. In step 350, with respect to the artificial assisting signal, frequency reduction is performed on the average envelope E_{MEAN} to construct a frequency-reduced average envelope E_{MEAN,FR}. In step 360, the frequency-reduced average envelope E_{MEAN,FR} is subtracted from the group of assisted data f_{A} to produce a component signal f_{C} (or a group of component data). In step 370, whether the component signal f_{C} satisfies a mode condition is checked. If so, the component signal f_{C} is regarded as a mode, that is, an intrinsic mode function IMFₖ (intrinsic mode function) as indicated in block 377, wherein k is set to 0 at the beginning, for example. If not, as indicated in step 375, the current assisted signal f_{A} is replaced by the component signal f_{C}, and the above sifting steps 330 to 375 are repeated until a mode conforming to the condition of step 370 is obtained.

After a mode is obtained (such as block 377), the method continues to search for the next mode as indicated in FIG. 3B. In step 380, the above obtained mode IMF is subtracted from the input signal f_{A} combined with the artificial assisting signal (i.e., assisted input signal f_{A}) to obtain a residual signal Rₖ, wherein k is set to 0 at the beginning. If it is determined in step 390 that the residual signal Rₖ cannot satisfy a decomposition stopping condition, then the input signal f_{A} combined with the artificial assisting signal is replaced by the residual signal Rₖ as indicated in step 395 and the method proceeds to step 330 to perform sifting for another mode IMFₖ₊₁ by way of iteration. Next, a residual signal Rₖ₊₁ is obtained according to the above method until at least one subsequent residual signal Rₙ satisfies the decomposition stopping condition.

It is noted that the embodiment of the invention is not limited to the above exemplification. FIG. 3B merely indicates an exemplary embodiment applying the concept of using an artificial assisting signal and performing frequency reduction to the EMD method. Thus, other EMD methods or other data processing methods which increase the orthogonality among the obtained modes by way of using an artificial assisting signal and performing frequency reduction, can be regarded as embodiments of the invention.

The embodiment according to the above methods of the invention can also be used for implementing a signal processing system 500 for mode decomposition as indicated in FIG. 5. The signal processing system 500, such as a computer system or a signal analyzer, includes an input unit 510, a processing module 520, an output unit 530 and a memory unit 540. The input unit 510 is for reading an input signal f_{IN}, which can be a one-dimensional or a multi-dimensional signal (or data). The memory unit 540, such as a memory, a hard disc, an optical disc or other storage devices, is for storing the input signal f_{IN} as a data signal. The processing module 520, such as a microprocessor, a multi-core microprocessor or array, a signal processor, a field programmable gate array (FPGA), or a specific chip, is for combining an artificial assisting signal and the above data signal to obtain an input signal f_{A} containing an artificial assisting signal and performing EMD to the data signal f_{A} combined with the artificial assisting signal by way of iteration to obtain a plurality of modes. During the process of mode decomposition, the processing module 520 performs frequency reduction to produce a frequency-reduced average envelope to produce a number of modes as indicated in step 20 of FIG. 3A or step 350 of FIG. 3B. Thus, the orthogonality among the modes produced by the processing module 520 is enhanced. Regarding this, examples will be provided below.

In addition, the output device 530, such as a display, a touch screen, a printing device, or a data output interface, is for outputting the modes for analyzing the above input signals. The touch screen is taken for example. Modes obtained by decomposition of a non-stationary, non-linear physical signal taken for example as an input signal of the signal processing system 500, such as computer system or signal analyzer are displayed on the screen for the user to analyze and observe, for example, in the analysis of medical electrocardiography or images. In another example, input data that have been stored, such as a two-dimensional image or one-dimensional or two-dimensional data, are read by the input device 510 for H-EMD processing. In an embodiment, the touch screen or the input interface can further be used for controlling mode decomposition, setting relevant parameters or conditions, or determining whether to produce supplementary modes, for example, by clicking an icon indicative of a mode to produce a number of supplementary modes. In addition, the mode can be outputted to other units or apparatuses or further processed by the processing module 520. For example, the modes are outputted to a transient frequency analyzing module (or the processing module 520) for performing Hilbert transform on the modes, and the result are displayed on the screen or outputted.

Referring to FIG. 6, a block diagram of an embodiment of a processing module 520 for mode decomposition is shown. The processing module 600 of FIG. 6 includes an operation device 610 and a sifting module 620. The operation device 610 combines an artificial assisting signal and the abovementioned data signal to obtain an input signals f_{A} combined with the artificial assisting signal, for example, by adding the artificial assisting signal and the data signal, subtracting the artificial assisting signal from the data signal, or multiplying the artificial assisting signal by a constant and then adding the product to the data signal. The above processing can be implemented by an analog or digital adder or multiplier or other operation circuits. In addition, the operation device 610 can be equipped with an artificial assisting signal generating circuit such as a random number generator or a noise generator, or a device that can produce an artificial signal such as a high-frequency pulse or data alternating between −1 and 1. The sifting module 620 is coupled to the operation device 610 for performing EMD on the input signal f_{A} combined with the artificial assisting signal by way of iteration to obtain a number of modes, wherein the sifting module 620 has the function of frequency reduction 625. The sifting module 620 can be implemented as a microprocessor, a specific FPGA, a logic circuit or a combination of digital circuits. Likewise, the frequency reduction 625 can be implemented by software or hardware. In some embodiments, the frequency reduction 625 can be designed as a circuit or software for frequency reduction with respect to a specific dimension or a number of dimensions, for example, frequency reduction with respect to one or two dimension, or with respect to one and two dimensions.

The processing module 600 can further include a control module 630, coupled to the operation device 610 and the sifting module 620, for controlling the operation device 610 and the sifting module 620. In an example, the control module 630, such as a logic circuit or an analog circuit, controls the operation device 610 to process the data signal, and controls the sifting module 620 to receive the input signal f_{A} and perform H-EMD on the received input signal according to the method of the embodiment of the invention.

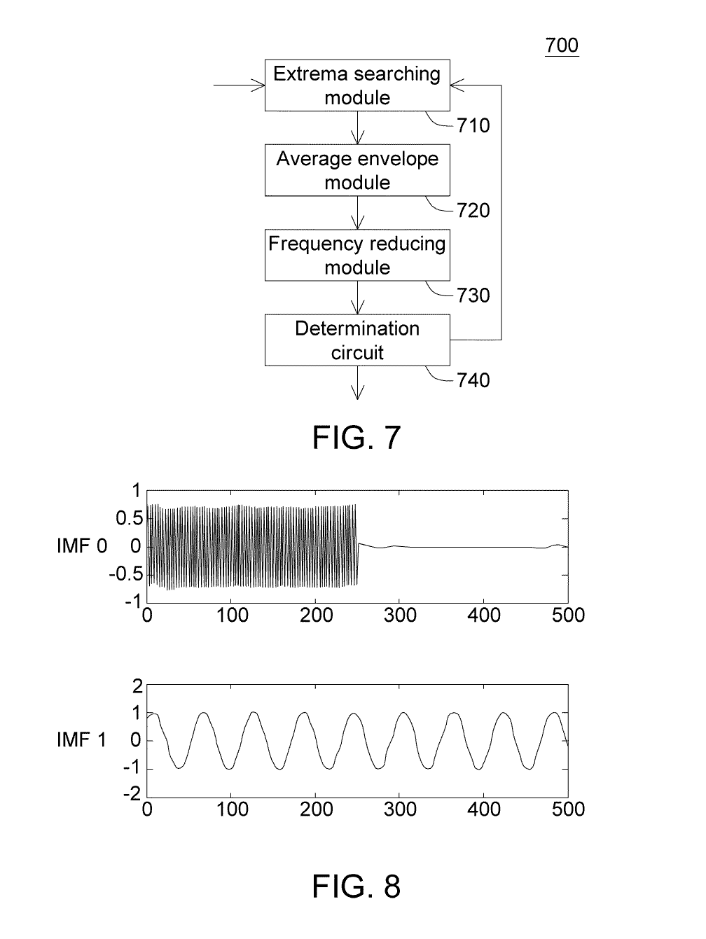

FIG. 7 shows a block diagram of an embodiment of a sifting module for mode decomposition. In FIG. 7, the sifting module 700, adopting a straight line configuration, includes an extrema searching module 710, an average envelope module 720, a frequency reduction module 730 and a determination circuit 740. The modules included in the sifting module 700 respectively achieve the functions indicated in step 330, 340, 350 of FIG. 3B by way of hardware. For example, the frequency reduction module 730 implements an embodiment of the multi-point smoothing process by performing weighted average with a digital circuit such as an adder, a multiplier, a register or other logic circuits, or implements an embodiment of the spectral filtering process with various analog or digital circuits such as digital low-pass filter or other logic circuits. The determination circuit 740 is implemented by a digital circuit or an analog circuit according to the condition indicated in step 370 or 390 to assist the completion of iterative computing so as to obtain a mode. For example, after the condition of convergence is satisfied, the determination circuit 740 directly outputs the mode or residual signal as an input to the extrema searching module 710 at the front end so as to proceed with the next mode decomposition. In the iteration of searching for modes, if the component signal cannot satisfy mode condition, then the determination circuit 740 outputs the component signal as an input to the extrema searching module 710 at the front end. Such configuration can perform iterative computing with smallest memory space and is not subjected to the number of decomposed modes.

The above embodiments disclosed in FIGS. 5-7 are not for limiting the implementation of the circuit which generates the mode according to the H-EMD. Anyone who is skilled in art can apply the concept of increasing the mode orthogonality by using an artificial assisting signal and performing frequency reduction according to the embodiments of the invention to implement further embodiments of the invention by modifying or adapting the above embodiments of the methods indicated in FIGS. 3A and 3B or by modifying the above examples of hardware configuration or using a different hardware configuration. For example, the H-EMD implemented through pipelining or parallel processing circuit still belongs to the embodiments of the invention.

The following will exemplify (1) the method for searching the extrema of data by using an artificial assisting signal, as indicated in step 320 and 330, and (2) the method for making envelope and noise converged at the same time by using frequency reduction during the search of modes, as indicated in steps 340 to 360. In addition, (3) the method for achieving H-EMD through the application of the embodiments of FIG. 3A or 3B are exemplified below.

The embodiments of the invention can be applied to one-dimensional and further to multi-dimensional decomposition. A one-dimensional signal and a two-dimensional multi-scaling ripple image are exemplified below, and the H-EMD can also be adaptable to other dimensions by deduction.

The embodiments of the invention are adapted to the situations when the dynamic range of an original signal is poor or when the data are not continuous. For example, the grey value image has 256 (such as 8 bits) color tones only, or the dynamic range of a signal is wide but the extrema are hard to define.

### (1) The Method for Searching the Extrema of Data by Using an Artificial Assisting Signal:

The extrema of data are divided into maximum values and minimum values, wherein the extrema are defined as the maximum values and the minimum values in the neighborhood. The extrema can be defined according to the extrema of signal intensity as in the conventional definition, or according to the extrema of signal curve. The problem occurring to the conventional search method of extreme values is that when the neighborhood comparison condition becomes strict, the extrema that should be selected will be missed. Especially, when the original signal image has a poor dynamic range or when the data are not continuous, such as square waves or equally spaced discrete signals, there is no neighboring points available for comparison during the search of extrema. Also, it is difficult to find a neighboring point for comparison during the search of the extrema when the dynamic range of signals is wide but the extrema are hard to define, for example, regions of such as a saddled wave or the crest or trough of a wave.

In an embodiment of the invention as indicated in the above step 320, an artificial assisting signal is added to assist the search of extrema. The condition for the artificial assisting signal is that any high-frequency signal has a constant average value (such as 0), for example, Gaussian distribution noise, uniform noise, equally-spaced signal artificially alternating between −1 and 1, and other high-frequency signals whose average values are constant. In a practical example, uniform noise is used as an artificial assisting signal. For example, the mode decomposition method is applied to a two-dimensional image, the addition of an artificial assisting signal to the image can be expressed by:

C_{—}2[i,j]=C_{—}1[i,j]+random[i,j];

wherein C_1[i,j] and C_2[i,j] denote the brightness value of the image originally at the coordinates (i,j) and that after an artificial assisting signal is added, respectively; random[i,j] denotes a random number of uniform distribution (−a, a), and a can be an integer. Also, the value of the random[i,j] can be appropriately set to be smaller than the dynamic range of the brightness value of the image C_1, such as 1, 2 or 5%, or 15% of the range of the brightness value of the original image (or the range of the amplitude of the signal). With a uniform random number being added, the search for extrema is made very simple, and even the square wave or the flat region has uniformly distributed extrema. Besides, the two-dimensional artificial assisting signal of the above example can further be adapted for signals of other dimensions.

As indicated in step 330, the maxima and the minima of a multi-dimensional signal with an artificial assisting signal being added are searched. For example, the extrema can be obtained by multi-point neighborhood comparison. The simplest method for two-dimensional neighborhood comparison is four-point search. For example, mode decomposition can be performed on an original two-dimensional image, as shown in of Exhibit 1A. If the original image data is treated as a three-dimensional image as in Exhibit 1B, then the height of one of the points of the image is the brightness of the image data, and the search for extrema is done by comparing one of the points with and its neighborhood. The search method of extrema is expressed as:

Maximum value Qmax=(includes)C_{—}2[i,j] if C_{—}2[i,j]>(C_{—}2[i−1,j],C_{—}2[i+1,j],C_{—}2[i,j−1],C_{—}2[i,j+1]);

Minimum value Qmin=(includes)C_{—}2[i,j] if C_{—}2[i,j]<(C_{—}2[i−1,j],C_{—}2[i−1,j],C_{—}2[i,j−1],C_{—}2[i,j−1]);

wherein Qmax is a set of maximum values (i.e., maxima) and Qmin is a set of minimum values (i.e., minima).

The introduction of noise effectively assists the search for extrema, and the elimination of noise must be done through frequency reduction which makes envelope and noise converge at the same time during the search of modes.

### (2) The Method for Making Envelope and Noise Converged at the Same Time by Performing Frequency Reduction During the Search of Modes:

As disclosed above, the introduction of an artificial assisting signal, such as random number, assists the search for extrema. The construction of envelope is disclosed in step 340. In an example, the envelope of one-dimensional signals or data is constructed by connecting the line interceptions of extrema. In an embodiment, the multi-dimensional envelope of multi-dimensional data is constructed according to extrema by adopting a physical field (the governing equation). A simpler method for constructing an envelope is done according to the steady state heat equation or the explicit non-stationary differential equation. After the data of extrema of an image are mapped into temperature, the above equations can be used for estimating the envelopes of the maxima and the minima and a first average envelope E_{MEAN}.

The average envelope includes an original signal and an interference of the added artificial assisting signal, and should be processed by an interference filtering process, that is, the frequency reduction indicated in step 350, to construct a second average envelope, that is, the frequency-reduced average envelope E_{MEAN,FR}. According to the embodiments of the invention, any frequency-reduction process capable of filtering or reducing the interference of artificial assisting signal can be adapted for implementation. For example, the smoothing process using the weighted average of neighboring points and the spectral filtering process can both be adapted for implementation.

The smoothing process, using the weighted average of neighboring points, treats a signal as a set of a number of points, and obtains a new value of a point through the weighted average of a number of neighboring points. The new values obtained by applying the same treatment to every point of the signal are viewed as the signal with respect to a first time of the smoothing process. As such, the signal with respect to the first time of the smoothing process can be repeated for once or many times according to the same smoothing process.

In an example denoted by formula, a trend carrier wave (can also be viewed as a signal or a group of data) is denoted by f (t), the smoothing window width is 2n+1, and the formula of smoothing process is expressed as:

$$SMOOTH ( \overline{f} ( t ) ) = {\sum }_{i = 1}^{2 n + 1} {w}_{i} \cdot f ( t + i - n )$$

$$wherein$$

$${\sum }_{i = 1}^{2 n + 1} {w}_{i} = 1.0$$

Next, after several times of frequency reduction, the trend carrier wave C (t) can be denoted as:

C(t)=SMOOTH( f̅(t)^{N-1})

wherein f̅=(t)^{j}=SMOOTH( f̅(t)^{j-1})
f̅(t)⁰=SMOOTH(f(t))

Let the 9-point smoothing process for two-dimensional data be used as an embodiment, wherein ENVELOPEmax denotes the envelope of the maxima, ENVELOPEmin denotes the envelope of the minima, and the ENVELOPEmean denotes the envelope of an average value group. In Exhibit 3A and 3B, a curved surface (in color) of a two-dimensional data obtained on the basis of the physical field, the envelopes of the maxima and the minima are the envelopes denoted in black curved surface in the Exhibites 3A and 3B respectively.

The average envelope can be denoted as:

Cmean=(ENVELOPEmax+ENVELOPEmin)/2.

The cancellation of artificial noises of the frequency reduced in average envelope Cmean can be applied by smoothing process with n-points window. For example, 9-points smoothing process in average envelope can be expressed as:

ENVELOPEmean[i,j]=(K₁Cmean[i−1,j−1]+K₂Cmean[i,j−1]+K₃Cmean[i+1,j−1]+K₄Cmean[i−1,j]+K₅Cmean[i,j]+K₆Cmean[i+1,j]+K₇Cmean[i−1,j+1]+K₈Cmean[i,j+1]+K₉Cmean[i+1,j+1])/9;

wherein ΣKᵢ/9=1.0. For example, the black envelope in Exhibit 3C denotes the frequency reduced average envelope of the envelopes of the maxima and the minima in Exhibites 3A and 3B after smoothing process.

Besides, for a point pᵢ of a one-dimensional signal, weighted average can be applied to the point pᵢ and its two neighboring points to obtain a smoothing value corresponding to the point pᵢ. For a point p(x,y,z) of a three-dimensional signal, weighted average can be applied to the point p(x,y,z) and its 26 neighboring points to obtain a smoothing value corresponding to the point p(x,y,z).

The above smoothing computing can be performed for N times or the value of the smoothing window width n can be changed, wherein the N and n are defined as N>2, n≧1. That is, the above first smoothed average envelope ENVELOPEmean[i,j] can be regarded as original data for the next smoothed average envelope, and such computing is performed for N times. For example, in the smoothed average envelope of Exhibit 3C, n=1, N=100. The values of N and n affect the number of the modes obtained in the decomposition finally. The search for the values of N and n will be disclosed in the appropriate smoothing condition of the hierarchical mode decomposition procedure.

The spectral filtering process can also be used as the frequency reduction of step 350. For example, the first average envelope can be transformed into a corresponding frequency spectrum by Fourier transformation F(ω)=FFT(f(t)) to obtain the frequency spectrum of a multi-dimensional function. Next, a low-pass filtering process (denoted by Lowpassfilter(•)) can be performed on the frequency spectrum to obtain a filtered frequency spectrum, and inverse transformation (denoted by IFFT (•)) can be performed on the filtered frequency spectrum to obtain a frequency-reduced average envelope. The above relation can be expressed as:

C(t)=IFFT(Lowpass filter(F(ω))).

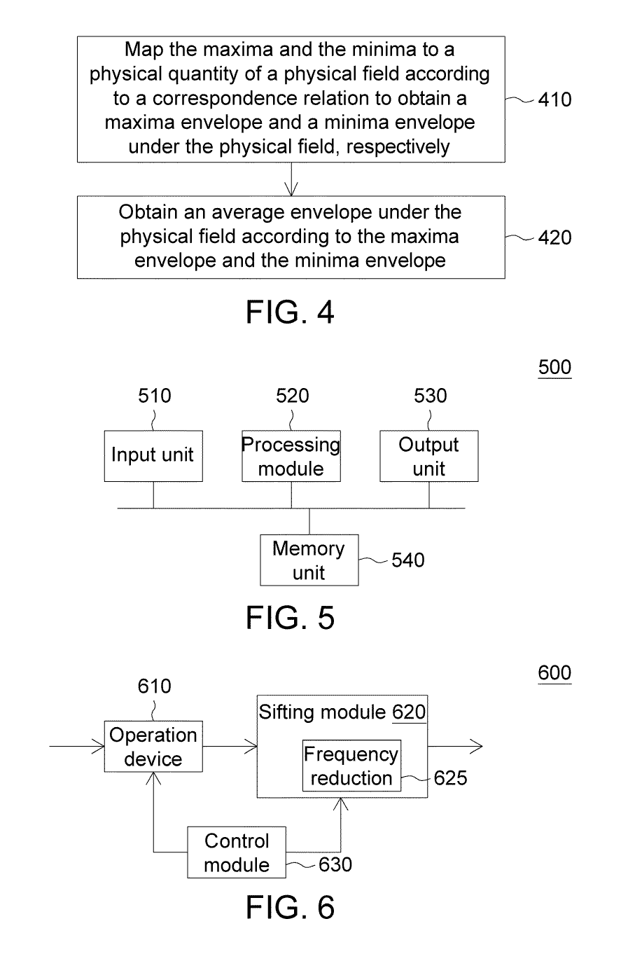

In addition, the generation of envelope is mentioned in step 340, and one of the implementations indicated in FIG. 4 includes the following steps. In step 410, the maxima and the minima respectively are mapped to a physical quantity of a physical field according to a correspondence relation to obtain the envelopes of the maxima envelope and the minima based on or under the physical field. In step 420, a first average envelope based on the physical field is obtained according to the maxima envelope and the minima envelope. As the value of the first average envelope is a physical quantity, such as temperature, in step 350, after frequency reduction, the first average envelope needs to be restored as a second average envelope according to the above correspondence relation, so that the values of the first average envelope, such as pixel values, can be consistent with the original multi-dimensional data. For example, 50° C. is transformed into image brightness 50. If the pixel values directly correspond to the values of a physical quantity, for example, the pixel values 0 to 255 directly correspond to the values (such as temperatures) of a physical quantity 0 to 255, there is no need to transform the former into the later.

In the above mapping step 410, the maxima and the minima correspond to physical quantities of a physical field according to a linear relation to respectively obtain a maxima envelope and a minima envelope under the physical field. For example, the brightness 128 is viewed as 128° C., the physical field is a thermal field, and the physical quantity is a temperature value in the thermal field. For example, the relation of the change in the physical field is a thermal field equation, which denotes the change in a thermal field along with the temperature change in the space, that is, thermal field distribution, and satisfies the equation of the calculation of the thermal field:

Ut=α(Uxx+Uyy+Uzz). (Equation)

The heat distribution can be obtained by using the above equations. For example, the obtained maximum value is applied to the calculation of matrix. The finite difference method, an algorithm used in thermodynamics, is iterated until the temperature becomes stationary and convergent. Further, the thermodynamics equation of stationary state can be used for obtaining the distribution of the thermal field fastly through the solution of matrix directly.

Exhibit 3A shows the maximum value obtained from two-dimensional data, wherein there are only a number of points and temperatures (the maximum values of the data) that are already known, and in original drawings, different colors denote different temperatures. According to the equation of physical field in thermodynamics, every position having a field of temperature distribution is calculated from the information (extrema) of Exhibit 3A.

Besides, when envelope and noise converge at the same time, the condition for convergence must be satisfied. In step 370, whether the mode condition is satisfied is determined. Indicated in step 390, whether the decomposition condition is satisfied is determined. Examples of the above conditions include whether the standard deviation of the signal (such as the component signal or the residual signal) related to the average envelope is smaller than or equal to a threshold. Preferably, the threshold is the minimum resolution unit of data or the effective unit of data. For example, if the data signal of HEMD decomposition is an 8-bit image and the data ranges from 0 to 255 (256 equal shares), then 1.0 is taken as a threshold value.

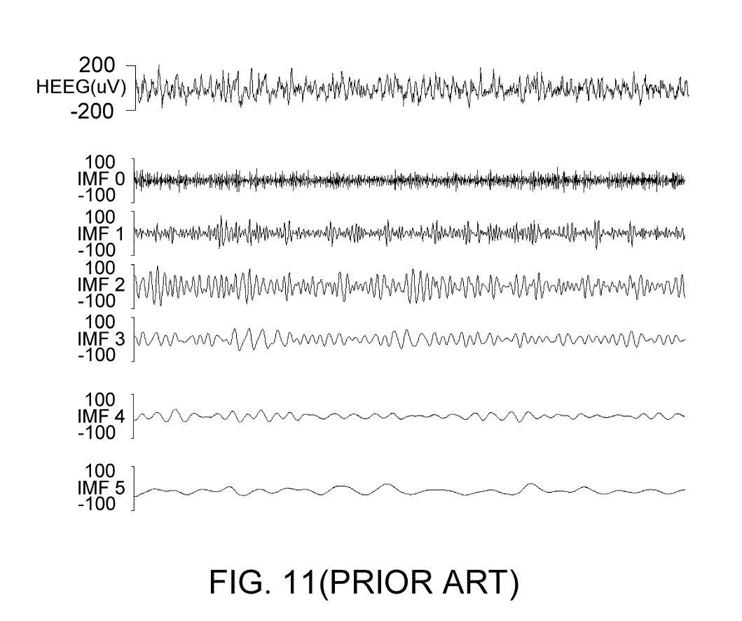

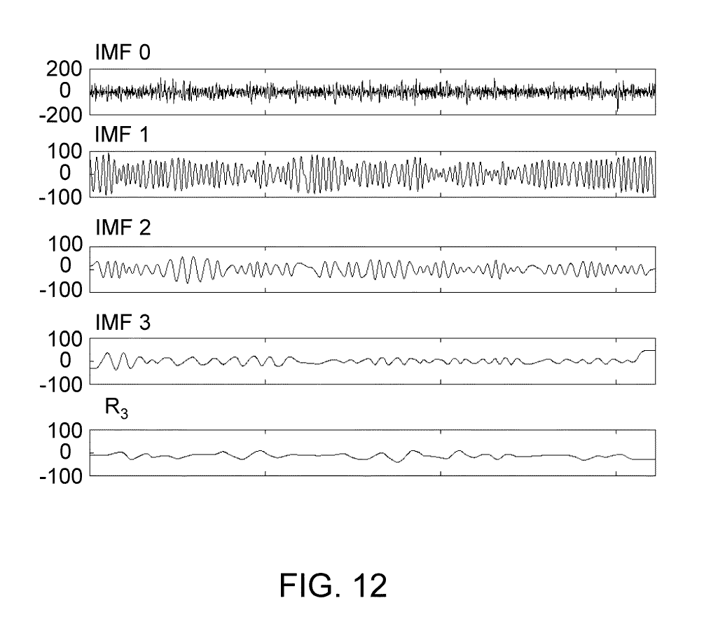

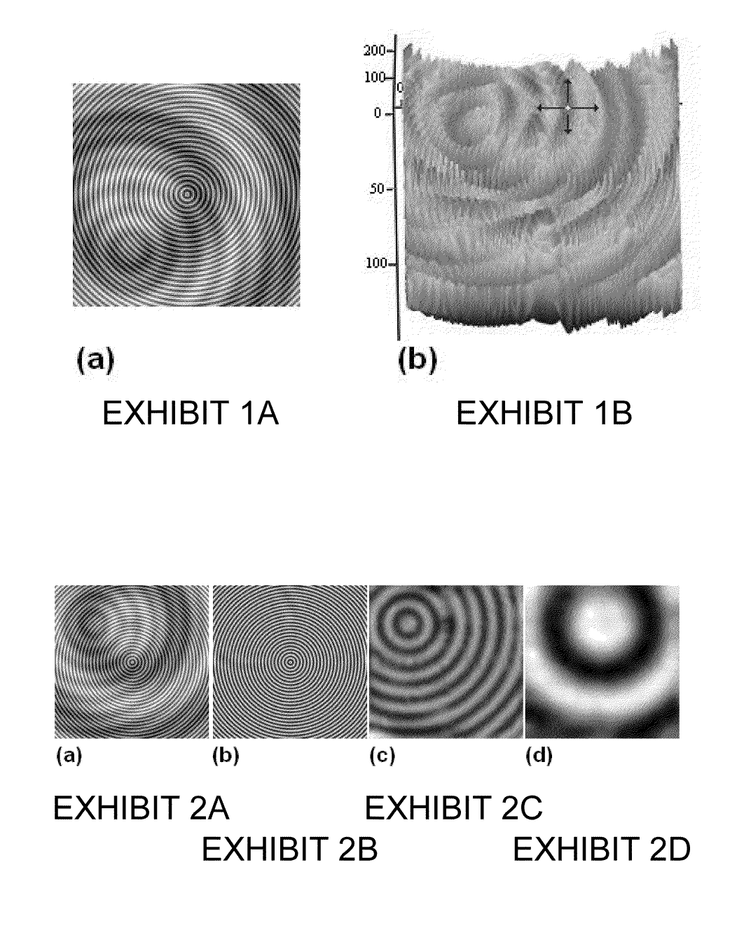

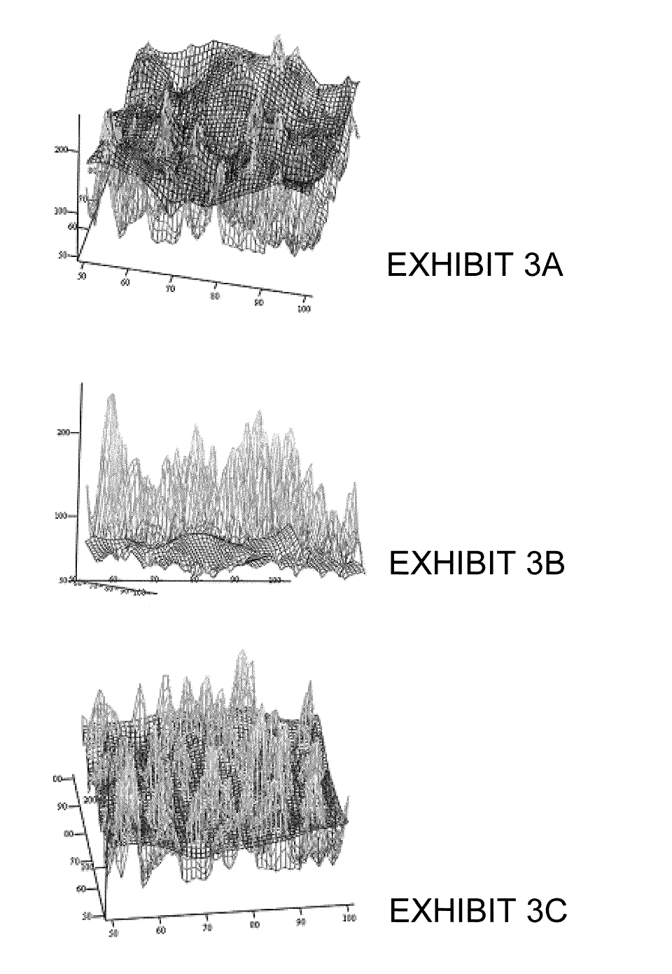

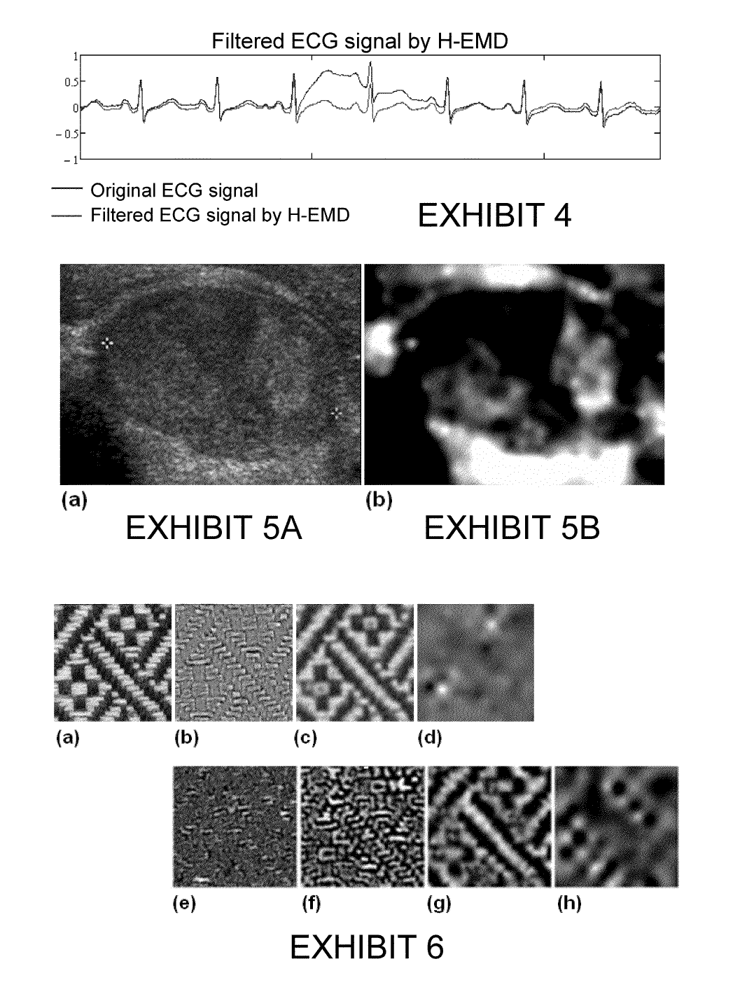

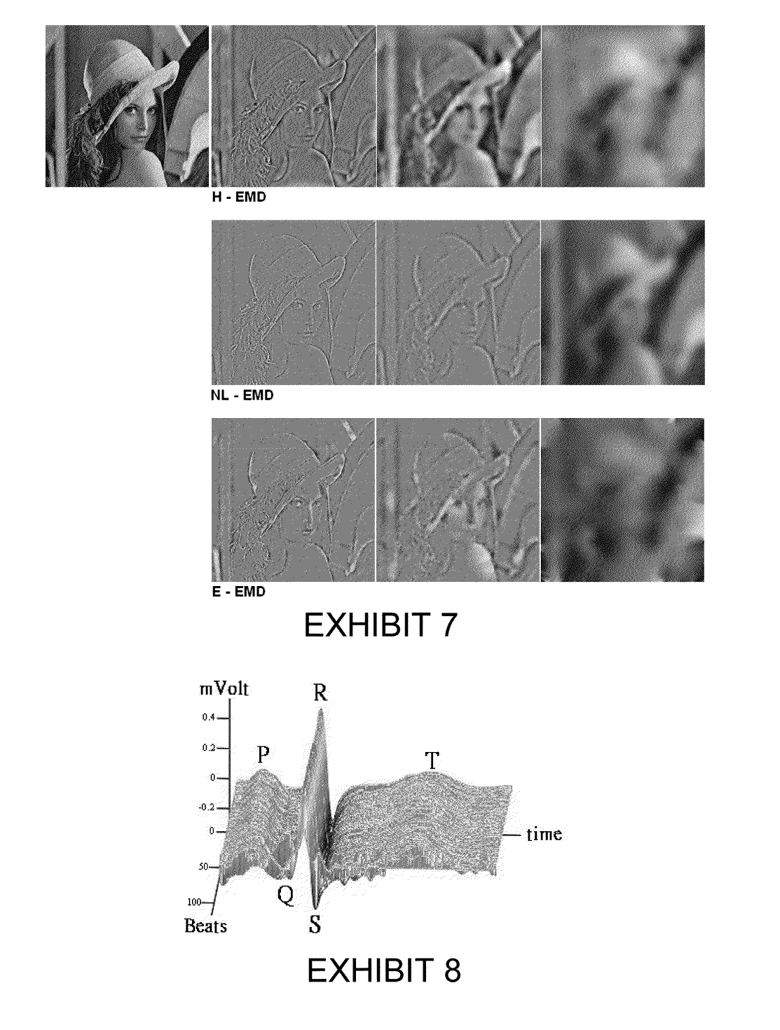

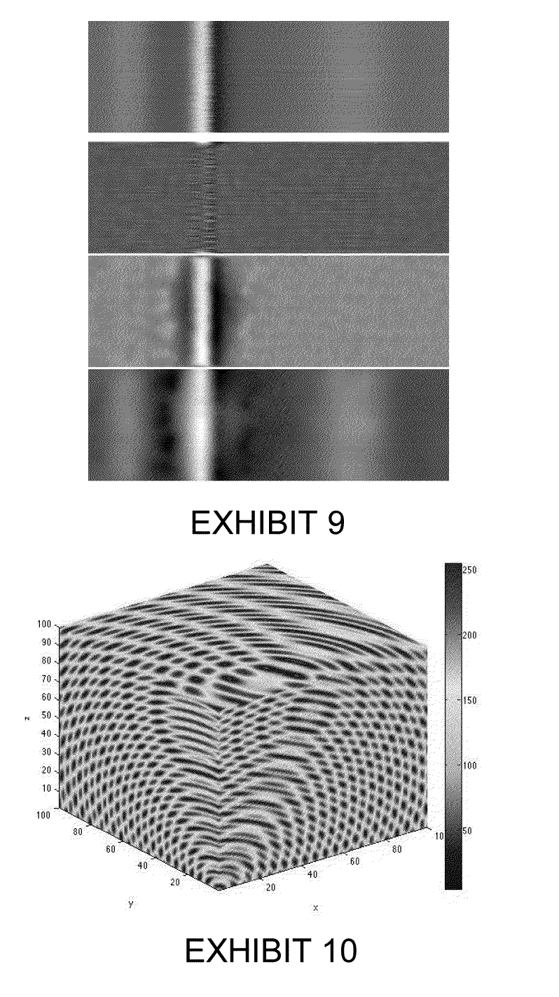

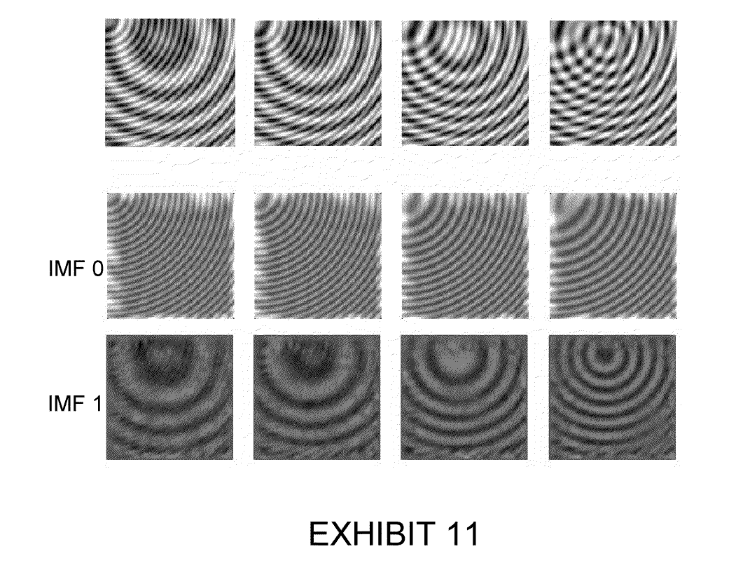

The H-EMD method according to the embodiments increases the orthogonality among the modes of decomposition by using an artificial assisting signal and frequency reduction, and the effect is exemplified by an example below. FIG. 11 shows a brain wave signal HEEG being decomposed into six modes IMF0 to IMF5 according to a conventional empirical mode decomposition. FIG. 12 shows the brain wave signal HEEG of FIG. 11 being decomposed into four modes IMF0 to IMF3 and the result of a monotonic function R₃ according to an example of hierarchical EMD method. Furthermore, the correlations between the modes of FIGS. 11 and 12 respectively are illustrated in the tables below:

TABLE 1

| | IMF0 | IMF1 | IMF2 | IMF3 | IMF4 | IMF5 | Residuals |
|---|---|---|---|---|---|---|---|
| IMF0 | 1 | 0.255 | 0.028 | 0.0037 | −0.002 | −0009 | 0.415 |
| IMF1 | 0.2554 | 1 | 0.39 | 0.057 | −0.0001 | −0.01 | 0.617 |
| IMF2 | 0.028 | 0.39 | 1 | 0.42 | 0.011 | −0.007 | 0.765 |
| IMF3 | 0.004 | 0.057 | 0.42 | 1 | 0.428 | 0.029 | 0.609 |
| IMF4 | −0.002 | −0.0001 | 0.011 | 0.428 | 1 | 0.265 | 0.348 |
| IMF5 | −0.009 | −0.01 | −0.007 | 0.029 | 0.265 | 1 | 0.227 |
| residuals | 0.415 | 0.617 | 0.765 | 0.609 | 0.348 | 0.227 | 1 |

TABLE 2

| | IMF0 | IMF1 | IMF2 | IMF3 | Residuals |
|---|---|---|---|---|---|
| IMF0 | 1 | 0.041 | −0.046 | −0.02114 | −0.033 |
| IMF1 | 0.041 | 1 | 0.032 | −0.006 | −0.03 |
| IMF2 | −0.046 | 0.032 | 1 | 0.041 | 0.031 |
| IMF3 | −0.021 | −0.006 | 0.041 | 1 | −0.00051 |
| Residuals | −0.033 | −0.03 | 0.031 | −0.00051 | 1 |

As indicated in Table 1, in the present example, the modes obtained by the E-EMD are still subjected to mode mixing. For example, from IMF1 to the residuals, the correlation coefficients between every two adjacent items are respectively 0.2554, 0.39, 0.42, 0.428, 0.265 and 0.227, and the correlation coefficients between the residuals and the modes range from 0.227 to 0.765. As indicated in Table 2, the modes obtained by the H-EMD method have higher orthogonality, from IMF1 to the residuals, the correlation coefficients between every two adjacent items are respectively 0.041, 0.032, 0.041, −0.00051, and the correlation coefficients between the residuals and the modes are all below 0.03. The above examples show that the embodiments of the H-EMD method are capable of resolving the problem of mode mixing occurring to conventional technologies and increasing the orthogonality among the modes.

### (3) The Hierarchical Mode Decomposition Procedure:

According to the conventional methods of mode decomposition including the EMD method and the E-EMD method, firstly, the modes are decomposed one by one, and then whether to filter the modes is determined according to the distribution of the frequency spectrum.

The concept of hierarchical mode decomposition is provided according to an embodiment of the invention. Firstly, data are decomposed into a small number of fundamental modes (e.g., the number normally ranges from 2 to 5 modes), and each of the fundamental modes can be further decomposed to produce a number of supplementary modes.

For example, in Exhibit 2A, three modes whose space dimensions are already known and different are mixed and used as an original file for testing the hierarchical empirical mode decomposition (H-EMD) of an embodiment of the invention. Exhibit 2B to 2D show three modes decomposed by the H-EMD and tested as correct modes.

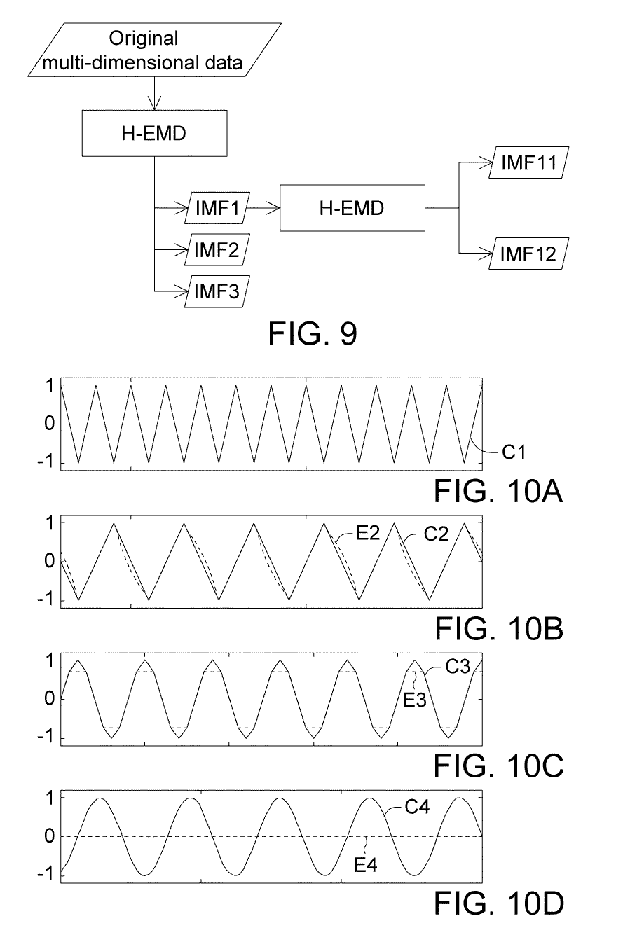

As disclosed above, the average envelope is smoothed for N times, and the smoothing window width is n. The larger the values of N and n, the fewer the number of the fundamental modes. To the contrary, the smaller the value of N is, the larger the number of the fundamental modes is. With appropriate smoothing condition being applied, the decomposition like the conventional EMD can be achieved. However, when an envelope is over-smoothed, hierarchical decomposition procedure can be used to produce a number of supplementary modes. The details of appropriate smoothing condition are given in the next section. After the smoothing is set as N times and the smoothing window width is set as n, m fundamental modes IMF1 to IMFm will be obtained, wherein m is an integer. If supplementary modes are needed, then the m fundamental modes IMF1 to IMFm can be decomposed one by one by the same method, and each of the fundamental modes can be further decomposed according to the signal processing method indicated in FIG. 3A or 3B to produce a number of supplementary modes. Thus, each of the fundamental modes can produce s first supplementary modes such as IMF11 to IMF1s, IMF21 to IMF2s, . . . , IMFm1 to IMFms, wherein m and s are integers larger than 1. Likewise, the average envelope can be smoothed to the first supplementary mode for N/4 times to obtain a second supplementary mode. As indicated in FIG. 9, the original input signal, such as multi-dimensional data, is firstly decomposed by the H-EMD method to obtain three fundamental modes IMF1 to IMF3, then the fundamental mode IMF1 is further decomposed to produce two supplementary modes IMF11 and IMF12, and the supplementary modes for the remaining fundamental modes can be obtained in the same manner.

### Appropriate Smoothing Condition:

The conditions required for appropriate smoothing are disclosed below. Let the trend carrier wave be denoted by f (t) and the smoothing window width be 2n+1. The smoothing equation for obtaining weighted average of neighboring points is expressed as:

$$SMOOTH ( \overline{f} ( t ) ) = {\sum }_{i = 1}^{2 n + 1} {w}_{i} \cdot f ( t + i - n )$$

$$wherein$$

$${\sum }_{i = 1}^{2 n + 1} {w}_{i} = 1.0$$

According to Fourier analysis:

$$f ( t ) = {\sum }_{i = 0}^{∞} ( {a}_{i} cos {w}_{i} t + {b}_{i} sin {w}_{i} t )$$

After being smoothed for one time, the signal after the smoothing window 2n+1 can be denoted as:

$$\overline{f} ( t ) = \frac{1}{n} {\sum }_{i = 0}^{∞} {\sum }_{k = - \frac{n - 1}{2}}^{\frac{N - 1}{2}} ( {a}_{i} cos {w}_{i} ( t + kT ) + {b}_{i} sin {w}_{i} ( t + kT ) )$$

Alternatively, it can be expressed as:

$$\overline{f} ( t ) = {\sum }_{i = 0}^{∞} {( \frac{1}{n} \cdot ( 1 + 2 {\sum }_{k = 1}^{( n - 1 ) / 2} cos {w}_{i} kT ) )}^{N} \cdot f ( t )$$

Therefore, the signal smoothed for one time and the original signal have the same frequency spectrum except that there are some occurrences of decay at high-frequency portions. In the current example, the intensity of decay is used for controlling whether the smoothing condition is appropriate.

After being smoothed for N times, the signal is expressed as:

$$\overline{f} ( t ) = {\sum }_{i = 0}^{∞} F ( {Ω}_{i} , n , N ) \cdot ( {a}_{i} cos {w}_{i} t + {b}_{i} sin {w}_{i} t )$$

wherein the decay equation is expressed as:

$$F ( {Ω}_{i} , n , N ) = {( \frac{1}{n} \cdot ( 1 + 2 {\sum }_{k = 1}^{( n - 1 ) / 2} cos {w}_{i} kT ) )}^{N} , 0 \leq {Ω}_{i} \leq π .$$

The appropriate smoothing condition is: N<, the smoothing window n should be obtained through optimal calculation. The correct computing for n should first of all define the intensity of decay, preferably, ranging 5% to 100%. In the present embodiment of the invention, when 10% or 0.1, and N=3, the decay equation is expressed as:

$$0.1 = {( \frac{1}{n} \cdot ( 1 + 2 {\sum }_{k = 1}^{( n - 1 ) / 2} cos 2 π k ω ) )}^{3}$$

wherein ω=0.5/(the interval between two consecutive extreme values)

The value of the smoothing window can be obtained from the above equation. The solution to the decay equation can be obtained according to the Bolzano-Weierstrass Theorem of numerical analysis. If the solution exceeds the value of n or N>3 or the optimal smoothing window, then fundamental modes are produced; otherwise, the modes obtained are similar to those by the conventional EMD method and generate more precise results.

Thus, if frequency reduction can be performed under appropriate condition, then different envelopes (surfaces) can have the same results of decomposition. For example, wave patterns illustrated in FIGS. 10A to 10D are obtained by decomposing an original signal by the H-EMD method and the EMD method respectively, and the abovementioned property that H-EMD can result in modes substantially independent of the form or the way of envelopes is verified by two different results of mode decomposition of envelopes, wherein the original signal is obtained by adding four signals C1 to C4 with four different wave patterns. In the other word, the H-EMD is truly a method to handle nonlinear and nonstationary signals without any prior basis in mode decomposition. The method of H-EMD and the method of adopting straight lines and cubic spline as envelopes and performing smoothing process to the envelopes respectively obtain two groups of modes each including four modes IMF1 to IMF4, wherein the four modes IMF1 to IMF4 are almost overlapped with the component wave patterns C1 to C4 of the original signal.

By comparison, the method of H-EMD and the method of adopting straight lines and cubic spline as envelopes and performing smoothing process to the envelopes respectively obtain two groups of modes each including four modes IMF1 to IMF4. As indicated in FIGS. 10B, 10C and 10D, the dotted lines E2, E3 and E4 respectively are the modes IMF2, IMF3, IMF4 obtained by the EMD method and the straight line envelope. The modes obtained by the EMD method and the cubic spline envelope are substantially the same with C1 to C4. Thus, the above example also indicates the unstability of the modes obtained by conventional EMD. That is, different enveloping methods lead to different modes. Therefore, the conventional EMD can hardly result in consistent modes and is not appropriate to the application of multi-dimensional signals.

In terms of the H-EMD according to the embodiments of the invention, the results of verification illustrated in FIGS. 10A-10D show that if frequency reduction is performed with appropriate condition, the embodiment of H-EMD can result in substantially identical decomposition to different envelopes (surface) and make the decomposition of modes more stationery and is independent of the form or the way of envelopes. Therefore, in H-EMD, the results of mode decomposition of envelopes obtained from different forms of envelopes, such as by way of straight lines and cubic splines, are considered to be the best for the EMD of one-dimensional signals and are substantially the same. Thus, the generation of modes is consistent and stable, and is applicable to the application of multi-dimensional signals. The forming of the above two-dimensional envelopes is merely for exemplification purpose, and the appropriate implementation of frequency reduction is independent of the forms of envelopes.

### Other Examples of Application of H-EMD:

Most applications only require fundamental modes. Thus, the hierarchical mode decomposition increases the efficiency of use and simplifies the process of application for there is no need to select from numerous modes, combine or eliminate data. For example, one-dimensional signal (electrocardiography signal) is decomposed into three fundamental modes by the H-EMD method, and normally the third fundamental mode is the background of the signal. The electrocardiography signal with the third fundamental mode being deducted can be used to filter signal fluctuations as indicated in Exhibit 4. For example, the ultra-sonic grey value image showing calcifying tumor (8 Bits) (as indicated in Exhibit 5A) is decomposed into three fundamental modes by the H-EMD method. Normally, the first and second mode are ultra-sonic noise (noise) and speckles, and the third fundamental mode can show calcifying spots as indicated in Exhibit 5B.

Referring to Exhibit 6 and 7, a comparison between the H-EMD method of the embodiment of the invention and the conventional EMD method is shown. In Exhibit 6, (a) denotes an 8-bit cloth-pattern image of the original signal. The signal is decomposed into three fundamental modes (b) (c) (d) by the H-EMD method of the embodiment of the invention, and is decomposed into the three modes (e)-(h) by the conventional E-EMD method. By comparison, the results of decomposition obtained by the H-EMD method are sounder, and the patterns thereof are decomposed according to high, medium and low level of resolution.

Exhibit 7 shows an example of the comparison of H-EMD, NL-EMD and E-EMD. The original image is composed of 8-bit grey values (the image at the left-top corner), the mode obtained by H-EMD (the 3 frames at the right of the top) has lowest level of mixing, optimum splitting in space scaling, and smoothest displayed frame, and the obtained modes IMF0 and IMF1 are correct modes. The frame obtained by NL-EMD (the 3 frames in the middle) is smooth but has severe level of mode mixing. The frame obtained by the E-EMD (the 3 frames at the bottom) has lower level of mode mixing and reasonable splitting in space scaling, but is rampant with grey points, and the displayed frame is not smooth.

Physical signals or biological signals can be viewed as two-dimensional signals (such as image) and decomposed by the H-EMD method. For example, Exhibit 8 is an example of electrocardiography which shows three-dimensional curved surface along with each change in the heart beat. An image at the topmost of Exhibit 9 is an example which views the electrocardiography of Exhibit 8 as a two-dimensional signal, wherein time and heart beat are viewed as independent variables, and the magnitude of voltage is viewed as a variable denoted by luminance, and the three following images are three modes obtained by the H-EMD. The R wave occurs at the second mode.

Besides, the H-EMD method is applicable to the mode decomposition of three-dimensional signals. For example, Exhibit 10 is an example of a three-dimensional blast wave, wherein the color denotes the diffusion of pressure. Exhibit 10 shows a three-dimensional diagram of two formulas wave₁ and wave₂ of combined blast waves. The formulas wave₁ and wave₂ are respectively expressed as:

wave₁=sin\sqrt{1.7i²+1.7j²+1.7k²}

wave₂=sin\sqrt{0.6(i−10)²+0.6(j−27)²+0.6(k−50)²}.

The data of the wave signal of Exhibit 10 are decomposed by the H-EMD method to test whether the results conform to the formulas of the two blast waves that are already known. Exhibit 11 is an example of three-dimensional H-EMD method, wherein the four images in the first row are sectional views of the blast waves of Exhibit 10. With respect to the above four sectional views, the four images in the second row obtained by the three-dimensional H-EMD denote the mode IMF0, and the four images in the third row denote the mode IMF1. The above results conform to the wave patterns obtained according to the formulas wave₁ and wave₂, and are correct modes.

The embodiment of the invention further discloses a computer or operation device readable storage medium on which programming code or one or several programming modules are stored. The programming code can be used for performing the H-EMD method of the embodiment of the invention. The computer readable storage medium of the present embodiment of the invention can be but not limited to optical information storage medium, magnetic information storage medium or memory such as memory card, firmware or ROM or RAM.

The signal processing method for H-EMD and the signal processing apparatus therefor disclosed in above embodiments have many advantages exemplified below:

(1) Mode mixing can be resolved. In an embodiment of the invention, when a multi-dimensional data (or multi-dimensional signal) is decomposed by empirical mode decomposition (EMD) method, an artificial assisting signal is added to the multi-dimensional data to assist the search for extrema and frequency reduction is performed in each iteration to eliminate the artificial assisting signal and make mode decomposition convergent, so as to result in frequency-band decomposition and reduce or even avoid the occurrence of mode mixing.

(2) In addition, a hierarchical empirical decomposition (H-EMD) method is provided in an embodiment, firstly, the data are decomposed into a fewer number of fundamental modes like an adaptive band-pass filter, and then, for needs in application, each of the fundamental modes is further decomposed to produce a number of supplementary modes. Thus, the computing time for multi-dimensional EMD can be largely reduced and the decomposition of data is more flexible and efficient. For example, in a practical example of an embodiment, the result of decomposition obtained by the H-EMD is many ten times faster than that obtained by the conventional EEMD method, and the hierarchical design is more flexible in application.

(3) In an embodiment, the hierarchical empirical mode decomposition with appropriate frequency reduction can result in modes substantially independent of the form or the way of envelopes.

It will be appreciated by those skilled in the art that changes could be made to the disclosed embodiments described above without departing from the broad inventive concept thereof. It is understood, therefore, that the disclosed embodiments are not limited to the particular examples disclosed, but is intended to cover modifications within the spirit and scope of the disclosed embodiments as defined by the claims that follow.

What is claimed is:

1. A signal processing method for performing empirical mode decomposition to an input signal, the method comprising:
combining an artificial assisting signal and the input signal to obtain an assisted input signal;
decomposing the assisted input signal by way of iteration according to an empirical mode decomposition (EMD) method to obtain a plurality of modes; wherein a frequency reduction for an average envelope is performed in each iteration to produce a frequency-reduced average envelope, and each mode is obtained by removing the frequency-reduced average envelope from the assisted input signal by way of iteration.

2. The method according to claim 1, wherein the artificial assisting signal is a random signal or a frequency signal, the frequency reduction is a multi-point smoothing process, and the artificial assisting signal increases orthogonality among the modes; the signal processing method further comprising:
outputting the modes, wherein the modes denote a plurality of fundamental modes of the input signal for analysis of change in the input signal.

3. The method according to claim 2, wherein the multi-point smoothing process comprises computing a weighted average of a point p on the average envelope and a plurality of neighboring points of the point p to obtain a point on a first smoothed average envelope corresponding to the point p.

4. The method according to claim 3, wherein the multi-point smoothing process further repeats the above computing step on the first smoothed average envelope to obtain a second smoothed average envelope, the multi-point smoothing process repeats the above computing step until an N-th smoothed average envelope is obtained as the frequency-reduced average envelope, and the smoothing times N is an integer larger than 2.

5. The method according to claim 4, wherein the number of obtained modes is determined according to the smoothing times N and size of the smoothing window.

6. The method according to claim 4, wherein the method further comprises:
taking one of the modes as the assisted input signal, and then performing the signal processing method according to claim 1 to obtain a plurality of corresponding supplementary modes, wherein the number of times of smoothing process performed on the mode is a half of the number of times of smoothing process performed for obtaining the mode.

7. The method according to claim 1, wherein the frequency reduction is a spectral filtering process.

8. The method according to claim 7, wherein the spectral filtering process comprises:
transforming the average envelope into a corresponding frequency spectrum;
performing a low-pass filtering process to the frequency spectrum to obtain a filtered frequency spectrum; and
performing inverse transformation to the filtered frequency spectrum to obtain a frequency-reduced average envelope.

9. The method according to claim 1, wherein the artificial assisting signal is a high-frequency signal whose average value is a constant.

10. The method according to claim 9, wherein the artificial assisting signal is a Gaussian distribution noise or a uniform noise.

11. The method according to claim 9, wherein the artificial assisting signal is an equal-distance signal.

12. The method according to claim 1, wherein in each iteration of decomposing the assisted input signal by way of iteration, the method further comprises:
determining maxima and minima of the assisted input signal;
constructing a maxima envelope and a minima envelope according to the maxima and the minima respectively;
constructing an average envelope according to the maxima envelope and the minima envelope;
performing the frequency reduction on the average envelope to construct a frequency-reduced average envelope;
subtracting the frequency-reduced average envelope from the assisted input signal to produce a component signal;
wherein if the component signal satisfies a mode condition, then the component signal is regarded as a desired mode;
wherein if the component signal cannot satisfy the mode condition, then the component signal is regarded as the assisted input signal and another iteration is performed until a component signal corresponding to at least one subsequent iteration satisfies the mode condition, and the component signal corresponding to the subsequent iteration is a desired mode.

13. The method according to claim 12, wherein the step of decomposing the assisted input signal by way of iteration further comprises:
subtracting the mode obtained by way of iteration from the original assisted input signal to obtain a residual signal;
if the residual signal cannot satisfy a decomposition stopping condition, then the residual signal is regarded as the assisted input signal and another iteration is performed accordingly until a mode corresponding to at least one subsequent iteration satisfies the decomposition stopping condition.

14. The method according to claim 12, wherein the step of constructing a maxima envelope and a minima envelope comprises:
mapping the maxima and the minima into a physical quantity in a physical field and respectively obtaining the maxima envelope and the minima envelope under the physical field, according to the change relationship of the physical quantity in the physical field.

15. The method according to claim 14, wherein the physical field is a thermal field and the physical quantity is a temperature value in thermal field.

16. The method according to claim 14, wherein the change relationship of the physical field is a thermal field equation.

17. The method according to claim 1, wherein the input signal is a multi-dimensional signal or data.

18. The method according to claim 17, wherein the input signal is a multi-dimensional image signal or a multi-dimensional signal corresponding to physical measurements.

19. A computer readable medium used in an electronic apparatus with a buffer for a signal processing method for performing empirical mode decomposition, wherein after the electronic apparatus is loaded with the computer readable medium and is performed, the electronic apparatus can implement the method disclosed in claim 1.

20. A signal processing apparatus for performing empirical mode decomposition, the apparatus comprising:
an input device for reading an input signal;
a memory unit for storing a data signal of the input signal;
a processing module for combining an artificial assisting signal and the data signal to obtain an assisted input signal, and for performing empirical mode decomposition to the assisted data signal by way of iteration to obtain a plurality of modes, wherein the processing module performs a frequency reduction on an average envelope in each iteration to produce a frequency-reduced average envelope, and the processing module removes the frequency-reduced average envelope from the assisted input signal by way of iteration to obtain the modes; and
an output unit for outputting the modes.

21. The apparatus according to claim 20, wherein the frequency reduction is a multi-point smoothing process.

22. The apparatus according to claim 21, wherein the processing module performs the multi-point smoothing process to determine a weighted average of a point p on the average envelope and a plurality of neighboring points of the point p to obtain a point on a first smoothed average envelope corresponding to the point p.

23. The apparatus according to claim 22, wherein the processing module performs the multi-point smoothing process to further repeat the above operation of the multi-point smoothing process on the first smoothed average envelope to obtain a second smoothed average envelope, and the multi-point smoothing process repeats the above operation to obtain an N-th smoothed average envelope as the frequency-reduced average envelope, and the smoothing times N is an integer larger than 2.

24. The apparatus according to claim 23, wherein the signal processing apparatus further for:
taking one of the obtained modes as the assisted input signal, and then performing empirical mode decomposition to the mode by way of iteration to obtain a plurality of corresponding supplementary modes, wherein number of times of smoothing process performed on the mode by the processing module is a half of the number of times of smoothing process performed for obtaining the mode.

25. The apparatus according to claim 20, wherein the frequency reduction is a spectral filtering process.

26. The apparatus according to claim 25, wherein the processing module performs the spectral filtering process to transform the average envelope into a corresponding frequency spectrum, to low-pass filter the frequency spectrum to obtain a filtered frequency spectrum, and to perform inverse transformation to the filtered frequency spectrum to obtain a frequency-reduced average envelope.

27. The apparatus according to claim 20, wherein the artificial assisting signal is a high-frequency signal whose average value is a constant.

28. The apparatus according to claim 27, wherein the artificial assisting signal is a Gaussian distribution noise or a uniform noise.

29. The apparatus according to claim 20, wherein the processing module comprises:
an operation device for adding an artificial assisting signal to the data signal to obtain an assisted input signal;
a sifting module coupled to the operation device for performing empirical mode decomposition to the assisted input signal by way of iteration to obtain a plurality of modes.

30. The apparatus according to claim 29, wherein the processing module further comprises:
a control module coupled to the operation device and the sifting module for controlling the operation device and the sifting module to produce the modes.

31. The apparatus according to claim 20, wherein the output module comprises a display displaying the modes.

32. A signal processing apparatus for empirical mode decomposition, wherein the apparatus comprises:
an extrema searching module for receiving a first signal to determine maxima and minima of the first signal;
an average envelope module for constructing an average envelope according to the maxima and the minima;
a frequency reduction module for performing frequency reduction on the average envelope to construct a frequency-reduced average envelope;
a determination circuit coupled to the frequency reduction module, wherein if a component signal satisfies a mode condition, then the determination circuit outputs the component signal as a mode, and the component signal is obtained by subtracting the frequency-reduced average envelope from the first signal;
wherein if the component signal cannot satisfy cannot satisfy the mode condition, then the determination circuit outputs the component signal as the first signal of the extrema searching module.

33. The apparatus according to claim 32, wherein if the component signal cannot satisfy the mode condition, then the determination circuit outputs the component signal as the first signal of the extrema searching module to determine corresponding maxima and minima until at least one subsequent component signal satisfies the mode condition, and the component signal is a desired mode.

34. The apparatus according to claim 32, further comprising an operation device, wherein the operation device is for combining an input signal and an artificial assisting signal to output the first signal.

35. The apparatus according to claim 34, wherein the artificial assisting signal is a high-frequency signal whose average value is a constant or a Gaussian distribution noise or a uniform noise.

36. The apparatus according to claim 32, wherein the frequency reduction is a multi-point smoothing process.

37. The apparatus according to claim 36, wherein the processing module performs the multi-point smoothing process to determine a weighted average of a point p on the average envelope and a plurality of neighboring points of the point p to obtain a point on a first smoothed average envelope corresponding to the point p.

38. The apparatus according to claim 32, wherein the frequency reduction is a spectral filtering process.

39. The apparatus according to claim 38, wherein the processing module performs the spectral filtering process to transform the average envelope into a corresponding frequency spectrum, to low-pass filter the frequency spectrum to obtain a filtered frequency spectrum, and to perform inverse transformation to the filtered frequency spectrum to obtain a frequency-reduced average envelope.
